(19) United States
(12) Patent Application Publication
(10) Pub. No.: US 2018/0012118 A1
(43) Pub. Date: Jan. 11, 2018

(54) PREDICTIVE VISUAL AND VERBAL MENTORING

(71) Applicant: INTHINC TECHNOLOGY SOLUTIONS, INC., Salt Lake City, UT (US)

(72) Inventors: Jonathan Corey Catten, Holladay, UT (US); Oliver Neil, Sandy, UT (US)

(21) Appl. No.: 15/203,447

(22) Filed: Jul. 6, 2016

(51) Int. Cl. G06N 3/00; G09B 19/14; G06N 7/00; G09B 29/10; G06N 3/08

(52) U.S. Cl. CPC G06N 3/006; G09B 29/102; G06N 3/08; G06N 7/005; G09B 19/14

(57) ABSTRACT

Embodiments described herein are directed to providing contextually relevant cues to users and to providing cues based on predicted conditions. In one scenario, a computer system identifies a task that is to be performed by a user. The computer system accesses data structures to identify current conditions related to the identified task. The computer system then generates, based on the identified current conditions related to the task, contextually relevant cues for the task. The contextually relevant cues provide suggestive information associated with the task. The computer system further provides the generated cue to the user. In other scenarios, the computer system identifies anticipated conditions related to the task using accessed historical information, and generates contextually relevant cues based on the identified anticipated conditions.

### BACKGROUND

Computers and smartphones have become ubiquitous in today's society. These devices are designed to run software applications, which interact with computer hardware to perform desired functions. For instance, software applications may perform business applications, provide entertainment, facilitate turn-by-turn navigation, and perform many other types of tasks. In some cases, software applications may be designed to interact with other computing systems. Such communications can occur over different types of radios which are integrated into devices such as smartphones. Using such communications, computers and other devices can access vast stores of information. This information may be used in a variety of contexts including machine learning, analytics and big data applications.

### BRIEF SUMMARY

Embodiments described herein are directed to providing contextually relevant cues to a user and to providing cues based on predicted conditions. In one embodiment, a computer system identifies a task that is to be performed by a user. The computer system accesses data structures to identify current conditions related to the identified task. The computer system then generates, based on the identified current conditions related to the task, contextually relevant cues for the task. The contextually relevant cues provide suggestive information associated with the task. The computer system further provides the generated cue to the user.

In another embodiment, a computer system provides cues based on predicted conditions. The computer system identifies a user and accesses historical data related to a task that is to be performed by the identified user. The computer system also identifies anticipated conditions related to the task using the accessed historical information and/or current conditions (directly or indirectly), and generates, based on the identified anticipated conditions, contextually relevant cues related to the task that provide suggestive information associated with the task. The computer system then provides the generated contextually relevant cue to the user.

In another embodiment, a graphical user interface is provided by a computer system. The graphical user interface (GUI) includes the following: an initial screen that allows users to view and evaluate contextual information related to a task, a first cue card that has information related to the task, and a second cue card that includes interactive elements that allow a user to drill down into contextual information displayed in the second cue card to find additional contextual information related to the task. The computer system the computer system tracks inputs provided by the user to determine which cue cards are selected and which contextual information is determined to be relevant to the user. This allows future cue cards to be custom generated for the user based on the tracked inputs.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including providing contextually relevant cues to a user.

FIG. 2A illustrates an embodiment in which audible cues are provided within a vehicle.

FIG. 2B illustrates an embodiment in which visual cues and audible cues are provided within a vehicle.

FIG. 2C illustrates an embodiment in which audible cues are provided on a mobile device within a vehicle.

FIG. 3 illustrates an embodiment in which a visual cue is provided on a mobile device.

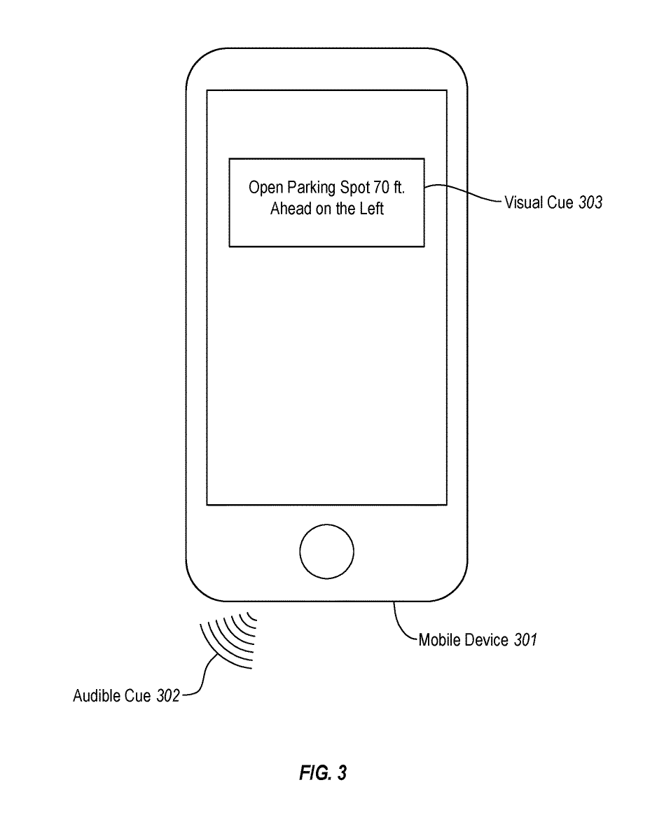

FIG. 4 illustrates a flowchart of an example method for providing contextually relevant cues to a user.

FIG. 5 illustrates a flowchart of an example method for providing cues based on predicted conditions.

FIG. 6 illustrates an embodiment in which an audio or visual cue is triggered while a vehicle is traveling.

FIG. 7 illustrates an embodiment in which an audio or visual cue directs a user to an empty parking spot in a parking lot.

FIG. 8 illustrates an embodiment in which an audio or visual cue is modified based on determining that a passenger is present in a vehicle.

FIG. 9 illustrates an embodiment in which a scheduling system identifies current and anticipated events based on public calendars, private calendars, event databases and other sources.

FIG. 10 illustrates an embodiment in which a visual cue provides the opportunity to select a relevant entertainment option.

FIG. 11 illustrates an example of a graphical user interface in which event elements may be provided and interacted with.

### DETAILED DESCRIPTION

Embodiments described herein are directed to providing contextually relevant cues to a user and to providing cues based on predicted conditions. In one embodiment, a computer system identifies a task that is to be performed by a user. The computer system accesses data structures to identify current conditions related to the identified task. The computer system then generates, based on the identified current conditions related to the task, contextually relevant cues for the task. The contextually relevant cues provide suggestive information associated with the task. The computer system further provides the generated cue to the user.

In another embodiment, a computer system provides cues based on predicted conditions. The computer system identifies a user and accesses historical data related to a task that is to be performed by the identified user. The computer system also identifies anticipated conditions related to the task using the accessed historical information, and generates, based on the identified anticipated conditions, contextually relevant cues related to the task that provide suggestive information associated with the task. The computer system then provides the generated contextually relevant cue to the user.

In another embodiment, a graphical user interface is provided by a computer system. The graphical user interface (GUI) includes the following: an initial screen that allows users to view and evaluate contextual information related to a task and/or condition, a first cue card that has information related to the task, and a second cue card that includes interactive elements that allow a user to drill down into contextual information displayed in the second cue card to find additional contextual information related to the task. The computer system the computer system tracks inputs provided by the user to determine which cue cards are selected and which contextual information is determined to be relevant to the user. This allows future cue cards to be custom generated for the user based on the tracked inputs.

Embodiments described herein may implement various types of computing systems. These computing systems are now increasingly taking a wide variety of forms. Computing systems may, for example, be mobile phones, electronic appliances, laptop computers, tablet computers, wearable devices, desktop computers, mainframes, vehicle-based computers, head units, tracking devices, and the like. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems. Some embodiments described herein may be implemented on single computing devices, networked computing devices, or distributed computing devices such as cloud computing devices.

In some embodiments herein, a computing system may be implemented in or be part of a vehicle. The vehicle may include many different types of standalone or distributed computing systems, including embedded computing systems. In some cases, the vehicle may include controllers for the engine, brakes, suspension, climate control and other functions, vehicle monitoring systems, vehicle location systems (e.g. global positioning system (GPS), etc.). A vehicle monitoring system may be coupled to and in data communication with on board diagnostic system in a vehicle.

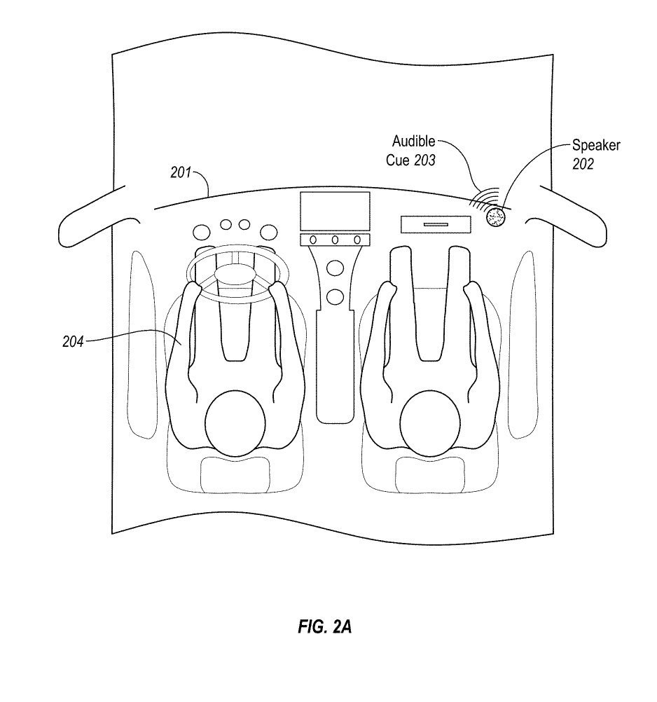

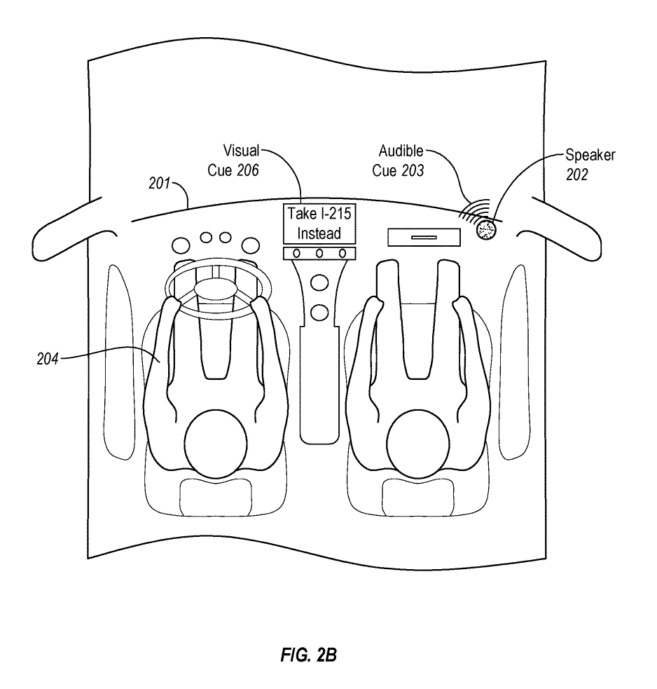

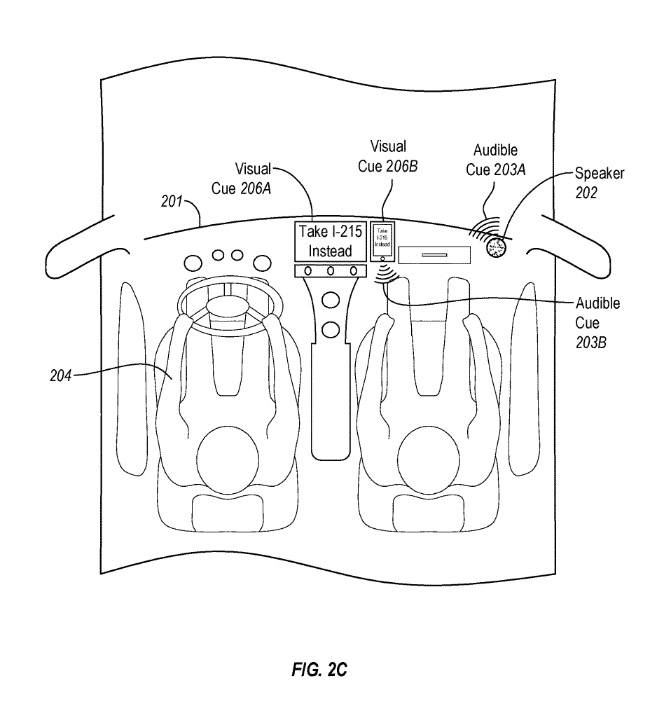

The vehicle monitoring system may have access to certain vehicle operating parameters including, but not limited to, vehicle speed such as via the speedometer, engine speed or throttle position such as via the tachometer, and mileage such as via the odometer reading. The vehicle monitoring system may also access and determine seat belt status and the condition of various other vehicle systems including anti-lock-braking (ABS), turn signal, headlight, cruise control activation and a multitude of various other diagnostic parameters such as engine temperature, brake wear, and the like. The vehicle monitoring system may also be coupled to driver displays and interfaces, such as warning lights or touch-screen display and/or speakers (as shown in FIGS. 2A-2C). The vehicle monitoring system may also be coupled to one or more additional sensors in the vehicle, such as a radio frequency (RF) sensor, camera, microphone, ethanol vapor sensor and the like.

Regardless of which form the computing system or systems take, they typically include at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well. Indeed, the vehicle may communicate with cloud databases, cloud processing networks and other remote systems.

These computing systems each execute code. As used herein, the term “executable module” or “executable component” can refer to software objects, routines, methods, or similar computer-executable instructions that may be executed on the computing system. The different components, modules, engines, and services described herein may be implemented as objects or processes that execute on the computing system (e.g., as separate threads). As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system. These computer-executable instructions may, for example, be implemented to instantiate a graphical user interface (GUI) in a infotainment system within a vehicle.

Still further, within the vehicle, different types of computer storage media are physical hardware storage media may be used to store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

Those skilled in the art will appreciate that the principles described herein may be practiced in network computing environments with many types of computing system configurations, including vehicle infotainment systems, smart phones, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, vehicle-based computers, head units, tracking devices, and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may interface with or be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed. Vehicles and smart phones may interact with such cloud computing environments to access data, determine which data is relevant, and provide contextually relevant cues to users.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

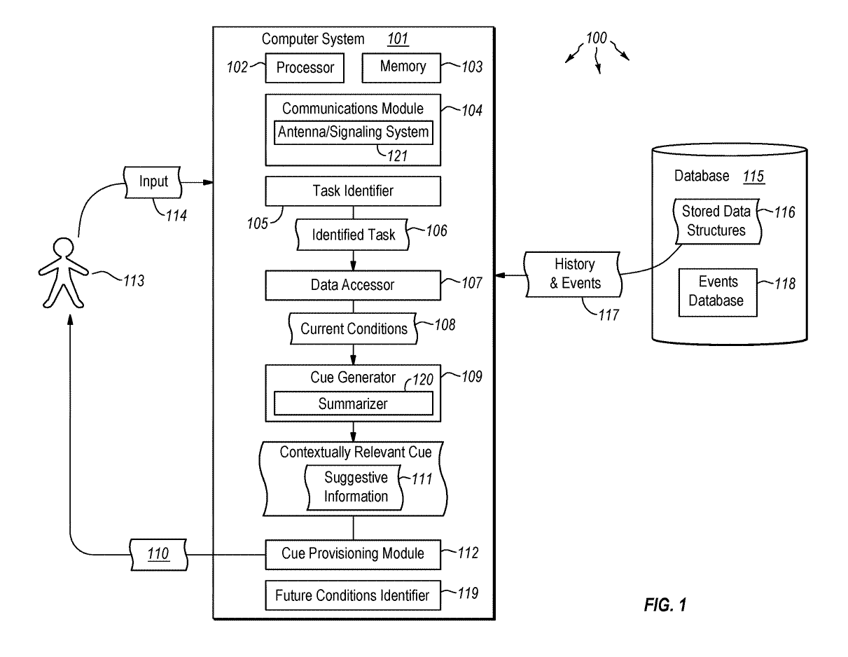

Referring to the figures, FIG. 1 illustrates a computer architecture 100 in which at least one embodiment described herein may be employed. The computer architecture 100 includes a computer system 101. The computer system 101 may be implemented in a vehicle or other environment. The computer system 101 may be a single computer system, or may be multiple computer systems. The computer system 101 may interact with a user 113 using touch inputs, mouse and keyboard inputs, gestures, voice commands or other inputs. In some cases, the computer system 101 may be a mobile phone, or may allow interaction with a mobile device (such as in cases where user 113 uses a mobile device to interact with the computer system 101). Thus, although the computer system 101 will often be described as being part of a vehicle here, it is not limited to such embodiments.

The computer system 101 includes modules for performing a variety of different functions. For instance, the computer system 101 may include a communications module 104 configured to communicate with other computing systems. The communications module 104 may include any wired or wireless communication means that can receive and/or transmit data to or from other computing systems. The communications module 104 may thus include hardware receivers, transmitters, transceivers or other radios capable of communicating with other computing systems. The communications module 104 may also include antennae and/or signaling systems 121 configured to communicate with local or remote computing systems including mobile and cloud computing systems. The communications module 104 may also be configured to interact with databases (e.g. 115), embedded computing systems, or other types of computing systems.

The computer system 101 further includes a task identifier 105. The task identifier 105 may be configured to identify tasks that are being performed or will be performed by a user or group of users. The tasks may be very simple, such as driving to work, or picking up a child from preschool, or may be complicated, such as running a series of errands or completing a set of deliveries which are time dependent, and which may be affected by surrounding conditions. Indeed, the data accessor module 107 of computer system may be configured to access data in a database to identify one or more current conditions. These conditions may be related to traffic such as traffic jams, wrecks, arrivals, departures, etc., or may be related to other events. The data accessor 107 may access stored data structures 116 and/or events database 118 on database 115 to identify these current conditions.

The stored data structures 116 may include current and/or historical data regarding certain events. For instance, in the vehicle traffic context, the stored data structures 116 may include historical data regarding traffic flow for certain streets or interstate highways at certain times of day. The historical data may also include historical data related to past events. This historical data in the stored data structures 116 may be continually and dynamically updated as new data is generated. Moreover, the data may be updated based on anticipated, future conditions.

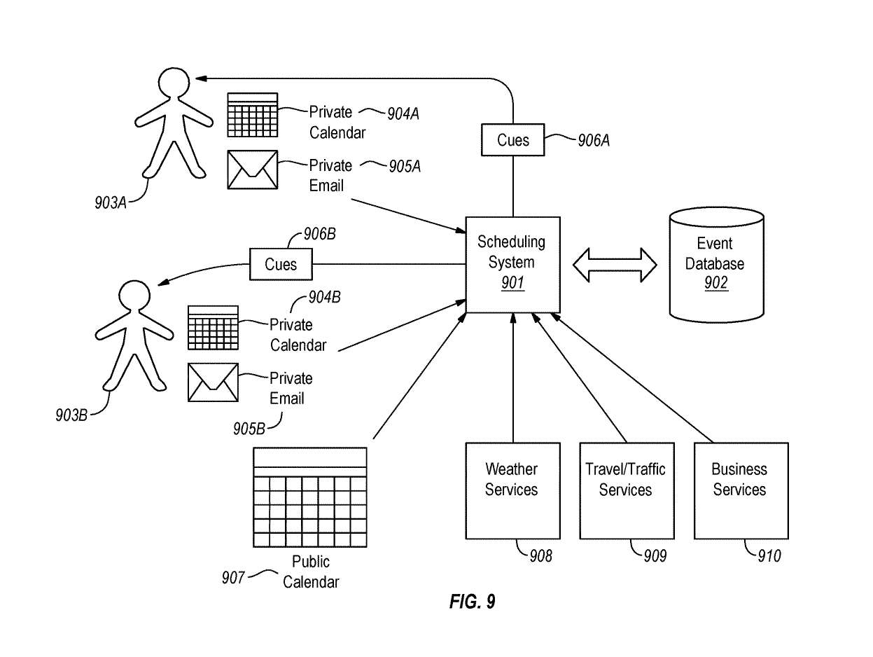

The events database 118, for example, may tie into different public and private event stores such as public calendars published by governments, universities, private businesses or other entities, as well as private calendars maintained on a user's mobile device, for example. In cases where a user (e.g. 113) allows the events database 118 to access their private calendar, the events database can provide trip information, meeting information, reminders, event information or any other type of information stored in the user's private calendar. Other databases may also be accessed when generating cues including weather databases, travel databases (including traffic databases), businesses or third party databases or other information stores (as will be discussed further with reference to FIG. 9 below). The cue generator 109 of computer system 101 can then use any or all of this information to generate cues.

As used herein, the term “cues” or “contextually relevant cues” may refer to audible, visible, tactile or other means of communicating a message to a user that intends to provide useful and contextually relevant information to that user. These cues are thus intended to help the user to complete a task in an efficient manner. The cue generator 109 may look at the current conditions 108, as well as historical data in the stored data structures 116 and events identified in the events database 118, to generate a cue 110. The cue may be generated if the information that is to be provided in the cue is determined to be sufficiently relevant to the user. Relevancy may be indicated by a user's subscription to such cues, or may be learned through recursive training.

For example, suppose a driver drives to work each day and the computer system 101 knows which route(s) the driver usually likes to take. If the user turns onto interstate 15 (I-15) every day, there is no need to tell the driver when to turn to get onto I-15. In such cases, the cue generator 109 would determine that that information is not sufficiently relevant to the user 113, and as such, would not expend the processing and data bandwidth resources needed to generate and provide the cue 110. If, however, the computer system 101 determined, based on one or more current conditions 108, that I-15 was backed up and that another road would be more efficient, the cue generator 109 may generate a cue 110 with suggestive information 111 informing the user that a different route would be better. Similarly, a cue may not be generated until the user has driven past or is close to driving past an intended destination. These embodiments will be explained further below, but it should be understood that the cue generator 109 does not generate cues 111 based on every piece of information retrieved from the database 115. Rather, cues are only generated when determined to be sufficiently relevant to the user.

Then, when a cue 110 is generated, that cue may be generated in a minimalistic fashion, such that only that information which truly needs to be imparted is provided to the user. Indeed, the cue provisioning module 112 may include logic that determines which method of delivery would be best in any given situation, and may use that method of delivery to provide the cue. Thus, if the user is merging into traffic on a highway, the computer system 101 can determine that the user 113 would not be able to look at a visual cue, and would instead provide an audible or tactile cue to the user. The summarizer 120 of the computer system 101 may be configured to generate varying levels of summarization vis a vie the cue. As such, the cue may be longer or shorter based on user preferences or based on context. In many cases, the cue will likely be short and easy to understand, and would be summarized to include just enough pertinent information (whether textual, audio, video, etc.) to be helpful given the current context. If the user wants more information related to a cue, the user can simply speak into a microphone within the vehicle, or interact with the infotainment system (e.g. touch a button on a touchscreen), or otherwise interact with the system.

As shown in FIG. 2A, a driver 204 of a vehicle 201 may have access to visual, audio or other cues via speakers within the car, via a touchscreen display that is part of an infotainment system, via a smartphone that is communicatively connected to the vehicle's infotainment system or via some other channel. FIG. 2A illustrates an embodiment in which the driver 204 and any other passengers that are present in the vehicle may receive an audible cue 203 through speaker 202. This cue may be generated by the cue generator 109 of computer system 101. The cue 203 may be a short verbal cue that imparts information to the driver 204 and/or the passengers. The cue may, for example, indicate that a preferred route is under construction, or is experiencing heavy traffic, and that another route would be more efficient. The cue 203 may be longer or shorter depending on which type of information is to be imparted, or depending on who the driver is.

Indeed, in some embodiments, various types of information may be used to identify the driver of the vehicle. The system 101 may look at historical data, for example, to determine that a certain driver typically enters the car at a certain time each day (or within a certain time window), or that a certain driver follows a known route (e.g. a route to work). Additionally or alternatively, the system 101 can look at in-vehicle cameras or ignition key identifiers associated with the user. Biometric information may also be used, which is detected by biometric scanners or sensors within the vehicle such as voice analyzers, fingerprint detectors, iris scanners, or even a weight detector in the seat that detects the user's weight. Still further, the system 101 may look at which settings the driver chooses for seat controls, climate controls, entertainment (e.g. radio stations) or other settings which may give contextual clues as to who the driver is.

The system 101 may also be configured to communicate with electronic devices associated with the driver 204. For instance, if the driver 204 has a smartphone, table or wearable device that has a radio transmitter (e.g. Bluetooth or WiFi), the computer system 101 may interact with that device using communications module 104. Once the device is identified, it may be assumed that the user associated with the device is the driver 204. This assumption may be verified or at least bolstered using any of the other types of contextual information identified above. It will be understood that any of the above types of information may be used, alone or in combination, to identify the driver 204. Similarly, any of these types of information may be used to identify a passenger. As will be shown below, the audible and other cues provided by the system 101 may be modified depending on who is present in the vehicle. For instance, if the driver's son is detected as being a passenger in the vehicle at 8 am, the system may determine that the driver's normal route to work will be different, as the driver will be dropping his son off at school before going to work. The audible cues 203 may thus be geared to the new school-first route, as opposed to the traditional work route.

FIG. 2B illustrates an embodiment similar to that in FIG. 2A, except that the cues are audible and/or visual. The audible cue 203 may be played through speaker 202, and the visual cue 206 may be displayed on a navigation or infotainment screen in the console. Each type of cue may be implemented at strategic times, based on the surrounding context. For instance, if the computer system 101 determines that the driver is looking at the display screen (e.g. while backing up the vehicle or changing radio stations), a visual cue may be provided which may be easily seen by the driver. If the system 101 determines that the driver is looking at a stop light or at surrounding traffic (e.g. via an on-board camera facing the driver), an audible cue may be used. Additionally or alternatively, the system 101 may use other sensors such as an external-facing camera to determine the current context of the vehicle. If the vehicle is merging onto freeway traffic, the system may delay the cue, or may sound an audible cue, as the driver is not likely to be looking at the console display.

Thus, it will be understood that the computer system 101 may take in many different types of sensor inputs, historical data inputs, and other determinations of context to determine which type of cue to provide and how to provide that cue. If multiple passengers are in the car and the interior noise is loud, the audible cue 203 may be played with increasing volume. If the visual cue 206 is not being looked at, it can implement a flashing screen, or larger print for the displayed letters, or use some other means of attracting the driver's attention. The visual cue 206 may be a reminder to pick up dry cleaning, to take a different route, to slow down due to stopped traffic ahead or due to weather conditions. In some cases, both a visual and an audible cue may be initiated to ensure that the driver receives the message.

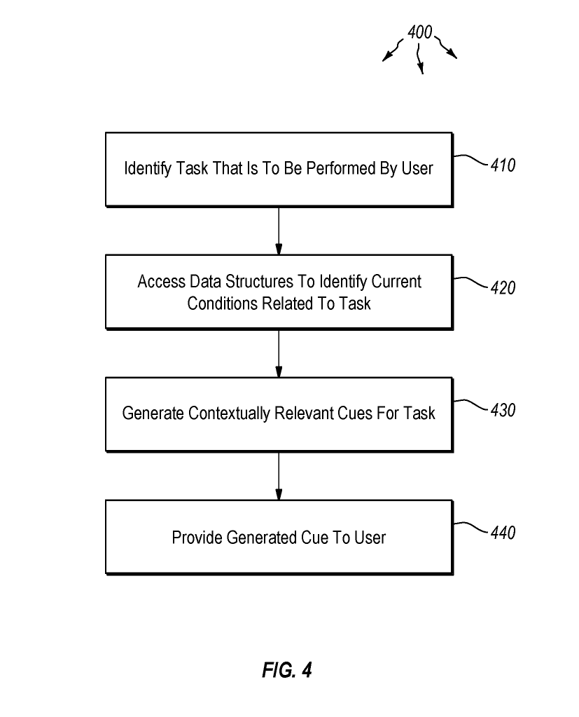

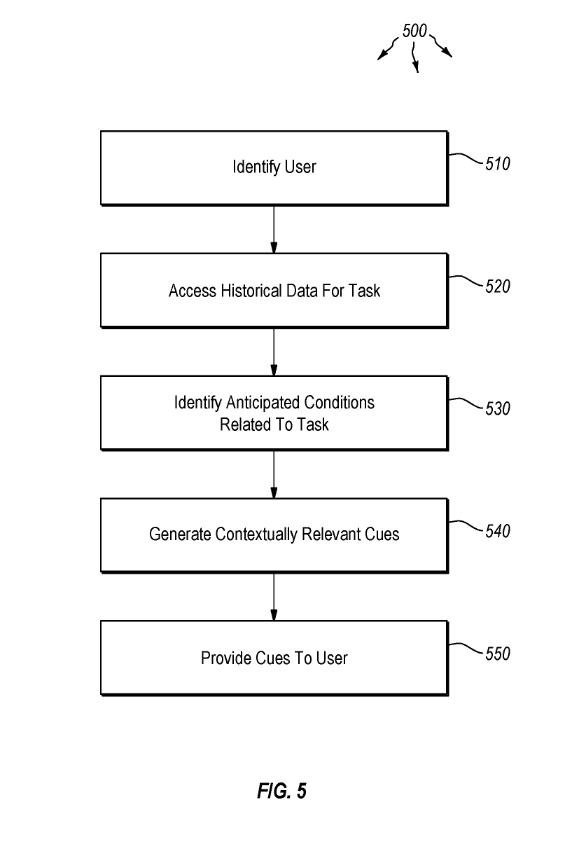

FIG. 2C illustrates an embodiment where visual and/or audible cues are provided over a smartphone or other mobile device that is communicatively connected to the computer system 101. Audible cue 203A may be sounded over speaker 202, and audible cue 203B may be sounded using the mobile device's speakers. Similarly, visual cue 206A may be displayed on the infotainment display, while visual cue 206B may be displayed on the mobile device. It will, of course, be understood that any of these cues may be initiated alone or in combination with the other cues. In some embodiments, if a user's electronic device is detected in the vehicle, all cues will be initiated on that device. This may be a setting that is configurable by the driver. Indeed, the driver may specify which cues are received over which mobile or vehicle devices. These concepts will be explained further below with regard to methods 400 and 500 of FIGS. 4 and 5, respectively.

In view of the systems and architectures described above, methodologies that may be implemented in accordance with the disclosed subject matter will be better appreciated with reference to the flow charts of FIGS. 4 and 5. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 4 illustrates a flowchart of a method 400 for providing contextually relevant cues to a user. The method 400 will now be described with frequent reference to the components and data of environment 100.

Method 400 includes identifying a task that is to be performed by the user (410). For example, the user 113 may be driver 204 of FIG. 2A. The driver may be beginning her drive home from work at the end of the day. The task identifier 105 of computer system 101 may identify the driver's task as returning home, or as driving to the gym, or as driving to a doctor's appointment. The data accessor 107 may access one or more data structures to identify current conditions related to the identified task (420) in order to determine how to best help the driver in completing their task. The data accessor 107 may look at stored data structures 116 (which include historical data related to the task) and/or events database 118 to identify events that may be directly or indirectly related to the task. These sources of information 117 may be used as indications of current conditions 108, and may be used to identify potential or anticipated conditions based on historical data or scheduled events.

For example, the events database 118 may tie into personal calendars (e.g. in user 113's mobile device) and public calendars. These calendars identify events that could provide context to the user's identified task 106. For instance, if the user 113 works downtown near a stadium or event center, the data accessor 107 may determine, from information 117 received from the events database 118, that an event such as a professional basketball game is happening that night. Other calendar events such as conventions, theater events or other types of events may be happening which will affect vehicle traffic in the area. The computer system 101 may look at the start and anticipated finish times for the event(s), look at the time the user is leaving work, and determine how the event traffic will affect the user's drive home (if at all). If so, a cue may be generated to advise the user of a different route.

Method 400 next includes generating, based on the identified current conditions related to the task, one or more contextually relevant cues for the task, where the contextually relevant cues provide suggestive information associated with the task (430). The cue provisioning module 112 then provides the generated cue 110 to the user (440). The cue generator 109 is configured to look at the current conditions 108 identified using the historical and events data 117, and generate a contextually relevant cue 110 based thereon. The contextually relevant cue 110 includes suggestive information 111 which may be verbal words or phrases, written words or phrases, graphics, videos or other types of information which may communicate the intent of the cue to the user. The user 113 can then choose to follow the suggestion of the cue, interact with the cue to find out why the cue was provided (i.e. what was the basis for generating the cue), or disregard the cue.

In some cases, the cue 110 may provide sub-tasks or suggestions associated with the generated cue that provide information indicating how the task is to be performed. For instance, if the task includes a new route to take, or if the task includes finding a parking spot in a crowded parking lot, the cue 110 may provide directions to the parking spot, or may provide turn by turn instructions on the new route. Alternatively, if the cue 110 includes an indication to run errands, the cue may provide information on each errand as a sub-task. The cue 110 may provide this information directly, or may segue the user into another application on the vehicle's computing system or on the user's mobile device, which may assist the user in completing the task 106.

In some cases, the cue 110 may be provided to the user 113 even when the user is not in their traditional vehicle or even when not in a vehicle. For instance, if the user is in a cab or airport shuttle or some other vehicle, the user may receive cues on their mobile device. Similarly, if the user is walking or at home or otherwise not in a vehicle, the user may still receive cues generated by the computer system 101. Regardless of the location of the location of the user 113, the generated cue may be a brief, highly relevant verbal and/or visual cue that tells the user to perform a specific task. In the context of vehicles and traffic, the generated cue 110 may be a task related to driving or a task that can be performed while driving or after driving (e.g. pick up dry cleaning or pick up a child from baseball practice).

The user's task may be affected by many different current and future or anticipated conditions. The current conditions 108 may include traffic conditions that are already present on the road, such as a wreck on the highway, or lane-narrowing due to road construction that has caused a backup. Current conditions may include weather conditions such as rain, snow, ice, high winds, or other weather-related conditions that may make the task more difficult to complete, or difficult to complete safely. If weather or traffic conditions are sunny and smooth flowing, generation of a cue 110 may be avoided, as these conditions would not likely pose any sort of impediment to the user completing their task. Other current conditions may include a local event that is happening in the area of the user (or has just let out) which may increase the volume of traffic in the user's area. Many other current conditions may be taken into account, and may be used as factors in determining whether or not to generate a cue and, if so, what type of cue to generate.

In one embodiment, the identified current conditions 108 may include a publicly or privately scheduled event that is accessible through a public events database or a private events database 118. For instance, the public events database 118 may indicate that a college football game is going to start in 30 minutes. The stored data structures 116 may indicate historical data on how traffic flows, both before and after a college football game. This information may be used when generating a cue for the user. The cue may indicate which streets typically get backed up when a college football game occurs in that city. This information, in combination with any detected current conditions, may provide a good indication of what the traffic flow will be like on the user's route, or when completing other tasks. Accordingly, public and private events may be location specific. Thus, cues may not be generated for all college football games, but may be generated for certain games, in certain cities at certain times. In this manner, the cues are generated dynamically and based on a plethora of different information, each piece thereof contributing to the generation of the cue or providing a reason why the cue does not need to be generated in the first place.

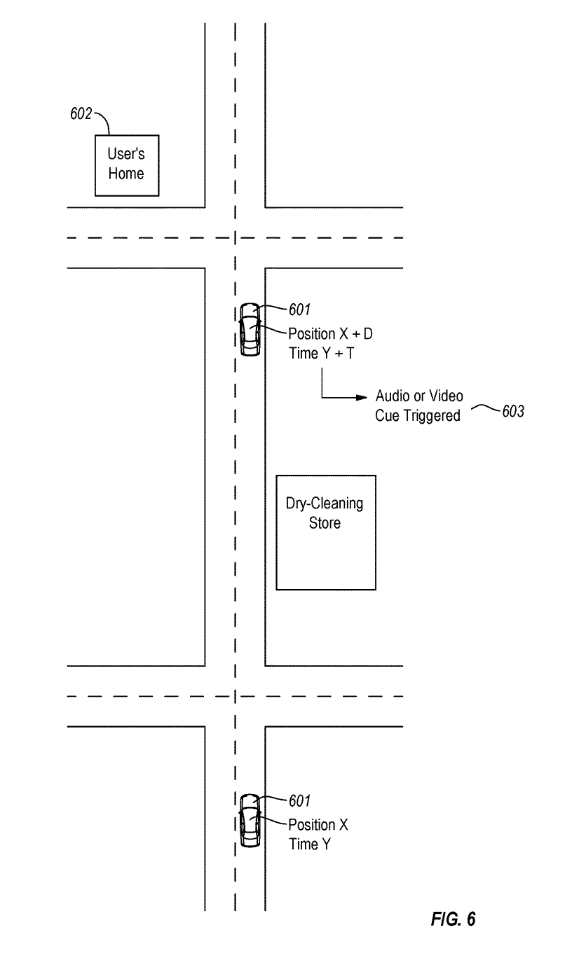

The data accessor 107 of computer system 101 may look at many different events in the events database 118. In the example above, the event was a public event published on a public calendar (i.e. a college football game published on a public-facing university calendar. In other cases, the data accessor 107 may have access to and look at private calendar inputs from users to determine current conditions based on events in the user's calendar. These private events may not affect traffic like a college football game would, but may be highly relevant when determining which route a user should take on their way home from work. For example, the user 113 may have an event in their calendar that indicates they are to stop by the grocery store to pick up some food items. The data accessor 107 may access this event and generate a cue to remind the user to stop at the store. As will be shown in FIG. 6, the cue generator 109 may wait to generate the cue 110 until it has determined that the user has forgotten to perform the task.

The cue generator 109 may include logic that involves deep learning and neural networks. The cue generator may use deep learning, neural networks, machine learning or other forms of computing to determine when cues should be generated and, when a cue is to be generated, how to generate the cue concisely and still convey its intended meaning. The logic of the cue generator 109 may thus determine what the shortest and/or simplest way of communicating the message is. The cue may be a single word or phrase spoken through a speaker or displayed on a monitor, or it may be a more complex series of cues, or series of words or phrases. Alternatively, the verbal or visual cue may be a symbol or sound that has meaning to the driver. In some cases, the cue may be a picture of the item or person the driver is to pick up, or a picture of the place to which the driver is to go. The logic of the cue generator 109 may learn the user's preferences over time, and may learn which means of notification are most effective, which are explicitly requested by users, and in which situations they are to be used. Thus, each cue may be generated with knowledge of the task, knowledge of the user and knowledge of the current conditions surrounding the user. Any or all of this knowledge may be used to enhance the relevancy of the cue 110.

Thus, over time, as the user 113 interacts with the computer system 101 (e.g. using input 114), the system can learn how the user behaves and which contextually relevant cues have the most impact. Cues that are (repeatedly) disregarded by the user may be suppressed in the future, whereas cues that may initially seem of lesser importance to the computer system's deep learning logic may be elevated in their level of relevancy due to the user's interest in the cues. As such, each generated cue is contextually relevant to that user. If the user has forgotten to rotate the tires or change the oil, the computer system 101 may generate a cue as a reminder. If the user forgets to roll out their trash cans for trash pickup, the computer system 101 may generate a cue 110 as a reminder, and so on.

The generation of cues may also be affected by passengers that are within the vehicle or are within radio range of the vehicle. The computer system 101 can determine that a specific passenger is in a vehicle using a variety of methods including identifying a mobile device associated with the user, using biometrics, using historical contextual data (e.g. seat settings or entertainment preferences), using in-vehicle cameras, or other user identification means. When a given passenger or group of passengers is detected, the cue generator 109 may take this into account when generating cues and when determining whether to generate cues.

For instance, if the driver had been alone, the cue generator 109 may have generated a cue regarding the user's route to work. However, since a group of children has been identified as passengers, the system may determine that it is a carpool day and the vehicle is most likely going to school. As such, cues may be generated for the new route. Similarly, if the passenger is determined to be a high-school-age boy, it may remind him that he has an assignment due in a specific class, or that a high-school-age girl has debate team practice after school. As will be understood by one skilled in the art, the knowledge of which passengers are in the car, and potentially having access to each of their private calendars, along with public school calendars, the cue generator 109 can create very specific cues that are highly relevant to each passenger, as well as cues that are relevant to the driver.

The above examples have focused heavily on making decisions regarding cue generation based on current conditions and historical data. FIG. 5 illustrates a flowchart of a method 500 for providing cues based on predicted conditions. These predicted or anticipated conditions may also affect the generation of cues, and may cause the cues to be generated differently than those solely based on current conditions and historical data. The method 500 of FIG. 5 will now be described with frequent reference to the components and data of environment 100 of FIG. 1, as well as FIGS. 6-11.

Method 500 includes identifying a user (510). The user (e.g. 113) may be identified by detecting a mobile device associated with the user, by identifying patterns in their inputs (e.g. infotainment or seat settings in a vehicle), based on their biometrics, or based on other indicators. In some cases, this step may involve identifying multiple users. For instance, step 510 may include identifying a driver and one or more passengers, or other members of a committee that are to attend a meeting, or other members of a sport team that are to practice together. Such groups may be identified by looking at public or private calendars that list participants in an event.

Method 500 next includes accessing one or more portions of historical data related to a task that is to be performed by the identified user (520). The historical data may be stored in data structures 116 in database 115. The data accessor 107 may access the stored data in relation to an identified task 106. The future conditions identifier 119 of computer system 101 may identify one or more anticipated or future conditions related to the task 106 using the accessed historical information 106 (530). The future conditions identifier 119 may, for example, look at calendar events, scraped emails, current conditions or other indicators to determine what may happen or what is likely to happen in the future.

In one vehicle traffic oriented example, the future conditions identifier 119 may determine that a music concert is to take place at a downtown venue at 7 pm. If this venue is a large venue capable of holding many thousands of people, the future conditions identifier 119 may determine that vehicular traffic on surrounding roads and highways will begin to build around 5 pm and will subside around 7:30 pm. The traffic will then greatly increase again at the time the concert lets out. In another example, if a wreck occurs on one highway, it often has predictable effects on other highways. Using this information, cues may be generated to warn a driver to avoid certain areas at certain times due to predicted high traffic.

Indeed, method 500 includes generating, based on the identified anticipated conditions, one or more contextually relevant cues 110 related to the task 106 that provide suggestive information associated with the task (540). These generated contextually relevant cues 110 are then provided to the user (550) by the cue provisioning module 112. The contextually relevant cues 110 may provide substantially any type of information, and the information does not need to be related to traffic. The cues may be related to anticipated weather, or anticipated online purchases (such as Black Friday), or anticipated air travel seat availability, or reminders to perform tasks that have been performed in the past and will likely need to be redone by an anticipated date. Thus, it can be seen that the cues may be generated for substantially any type of task, and may be generated using a variety of different inputs that can help predict conditions that are related to that task.

When identifying future, anticipated conditions, the computer system 101 may access stored data structures 116 which include historical information related to the task. This historical information may indicate what has happened in the past when an event occurs, such as a weather event or a public event. Many different indicators and data types may be stored in the database 115, and may be used to provide context when generating anticipated conditions. Additionally or alternatively, the future conditions identifier 119 of computer system 101 may access events database 118 to identify events that are planned. The events may include events from both public and private calendars. Each event or data structure may be used to piece together an accurate picture of what will happen both near the event and away from the event. Once the anticipated (and/or current) conditions are identified, a cue can be generated.

In at least one embodiment, the computer system 101 may be configured to calculate a likelihood or probability that an event will occur and (in some instances) an estimated timing of the likely event. Then, the likely event, if it occurs (particularly at the estimated time), will impact a path or activity that is associated with a user 113. Based on the probability or likelihood of reaching a predetermined threshold (e.g., 25%, 50%, 75% or any other predetermined percentage), the computer system 101 notifies the user 113 of the likely event and/or provides verbal mentoring to avoid the likely event.

In one instance, for example, a likelihood that a traffic jam will occur, which has not yet occurred, but which is calculated to occur by a certain probability (based on gathered data regarding surrounding events and/or other information) will impact the driving path of a user. The user 113 can be mentored, in such instances, to avoid certain roads and/or to take certain roads in their travels, so as to avoid the location where the event is ‘likely’ to occur. In a related, but alternative embodiment, the computer system 101 can also mentor the user to pursue the event, upon the likelihood of the event reaching a predetermined threshold. For instance, if a calculated likelihood of a congested roadway becoming uncongested at a relevant time is high enough, the computer system 101 may actually mentor the driver to pursue a path towards and/or including the (currently) congested road based on the predicted likelihood that the road will become uncongested.

In some cases, cues are only generated and provided to a user after determining that the cue is sufficiently pertinent to the user. For example, if the computer system 101 determines that you take a certain route to work every day, it may omit generation of a cue prompting the user to take that route. Instead, the contextually relevant cue 110 may only be generated if the user's normal route is closed or if traffic is particularly bad. In one example, the contextually relevant cue 110 may only be generated and provided to the user 113 upon determining that the user has forgotten to perform the specified task. In cases where the cue is not generated, processing resources are saved, and potentially unwanted cues are avoided.

As shown in FIG. 6, for example, if a user has a task of picking up dry cleaning at the dry cleaning store, the cue may not be generated until the computer system 101 has determined that the user forgot to perform the task, or has likely forgotten to perform the task. The driver 601 may be driving to their home 602, and may be passing a dry cleaning store along the way. When the driver 601 is at position X (before the store) at time Y, the computer system 101 may determine that the user is still on the way to the dry cleaning store, and may refrain from generating and presenting a contextually relevant cue. At position X+distance (D) at time Y+time (T), the computer system 101 may determine that the user has forgotten to perform the task and is instead heading home 602. At this point, the cue generator 109 may generate a contextually relevant cue 110 that is provided to the user to remind the user of the task.

In some embodiments, the cue may be generated at position X or at some position X+D where D is positioned before the turnoff to the store. This may be a setting that is configurable by the user. As such, the user may decide when to be reminded about tasks, especially in situations where the computer system 101 determines that the user has likely forgotten to perform the task. The user may choose a setting that provides more frequent reminders that are presented further away from the location of the task, or may choose a setting that provides less frequent reminders, or reminders that only come up after the system has determined that the task has been forgotten. In some cases, the generation of a cue or lack of generation may be based on the task itself. Thus, more frequent reminders may be given for urgent tasks, while less frequent reminders may be given for lower priority tasks. The user 113 may be able to assign a priority to each task so that the system knows how to handle cue generation for that task. Cue generation may be performed at some identifiable time before or after an event or condition, and this time may be configured by the user.

Additionally or alternatively, contextually relevant cues 110 may be location based. In such cases, the computer system may determine the current location of the user, and may provide the generated cue to the user 113 based on the user's current location. Some tasks may, for example, sit on in a user's task list until the user is in a certain area, or may only be relevant in certain areas. For instance, a cue may appear on a child's mobile device letting the child know to take the bus as the parent is not in the area and will not be able to pick the child up. A cue may appear on a child's mobile device letting the child know that his or her parent is on school grounds and is ready to pick him or her up. A parent may receive a cue indicating that a child in a carpool group is at the school already or is on the bus and, as such, the parent does not need to pick the child up. An employee may receive a cue indicating that a meeting is to start at a specified time and location if the system determines that the employee has not yet left for that meeting. A baker may receive a cue indicating that his or her cookies are going to burn if the system determines that the baker is at least a specified distance away from the oven. Many other scenarios are possible based on the user's location.

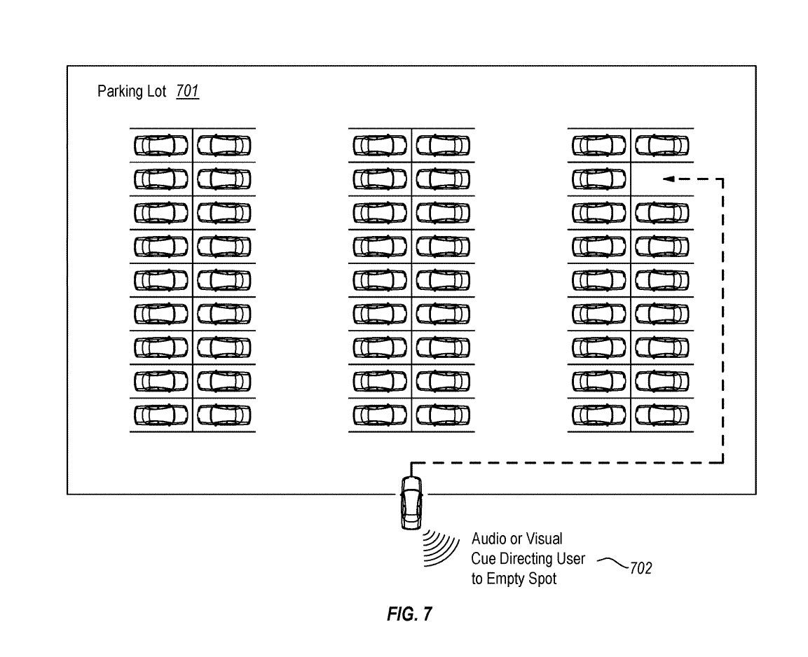

One example of a location-specific cue is shown in FIG. 7. Many times, users arrive at an event in a vehicle and need to find parking. FIG. 7 illustrates an embodiment where one spot is available in the parking lot 701. The data accessor 107 of computer system 101 may access many types of information related to that location in order to determine where the open spot is located. For instance, the data accessor 107 may access live-feed video data that shows the various spots in the parking lot 701 and determines which ones are empty. The data accessor 107 may also access data from sensors such as induction sensors that detect whether a vehicle is parked in the parking spot. Other information may be provided by users themselves, for example, by publishing that “Spot 117 is available” over a computer system (e.g. a cloud system) that communicates with other vehicle computer systems or mobile computer systems. Once the cue generator 109 has this information (i.e. 108) from the data accessor 107, the cue generator can generate a contextually relevant cue 702 for the user, directing the user to the empty parking spot.

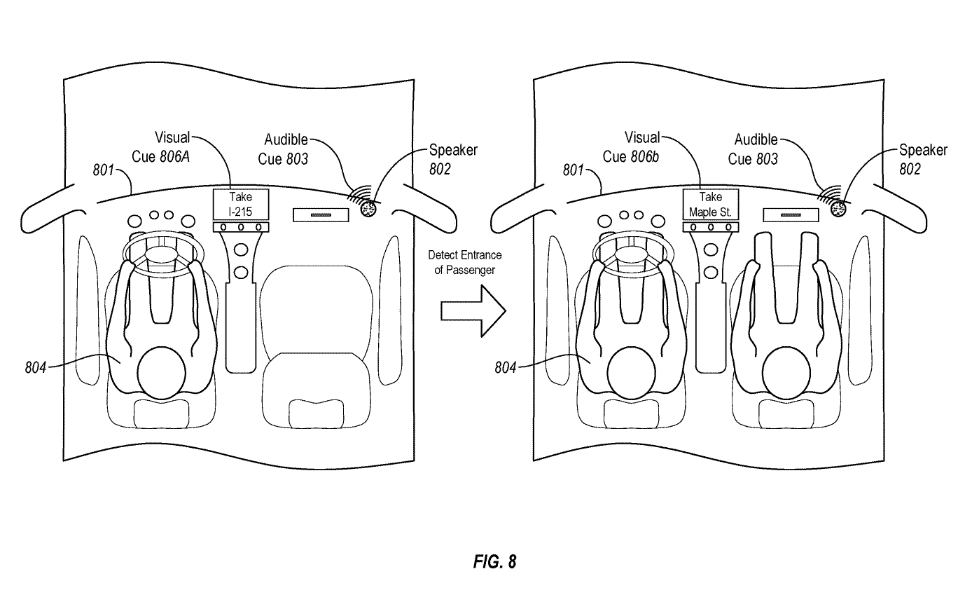

In addition to being location-sensitive, cues may also be user-sensitive. The same computer system in a vehicle may provide different cues to different drivers, based on each driver's habits and preferences. Similarly, the vehicle computer may provide different cues to the driver when different passengers are on board. For instance, as shown in FIG. 8, a driver 804 may be driving a vehicle 801 and may receive a visual cue 806A or audible cue 803 to take the I-215 route. If the computer system determines that a passenger has gotten on board, a different audible or visual cue (e.g. 806B) may be generated, indicating that the driver should take the Maple St. route. The different cue may be generated for a variety of different reasons.

In one example, the passenger may be a child that needs to go to school or daycare. As such, the driver may be taking a different route that accommodates the passenger. Alternatively, the computer system may know, from various public or private calendars, that the passenger is involved on a sports team, and that the sports team has a game that evening. The computer system 101 can then determine that the driver and passenger are headed to the location of the sporting event at which the passenger will play. Many different scenarios are possible and are contemplated herein. Succinctly put, each passenger may affect the generation of cues: whether the cues are generated at all and, if so, what content is provided in the cue.

FIG. 9 shows an example where a scheduling system 901 may be implemented to determine when events are scheduled, where they are located, and who is going to those events. The scheduling system 901 may be part of computer system 101, or may be computer system 101. The scheduling system 901 may have access to various calendars including private calendar 904A of user 903A, private calendar 904B of user 903B, as well as public calendar 907, which may show community and other events. The scheduling system 901 may (at least in some cases) have access to private emails 905A, text messages or other data associated with user 903A, as well as private emails 905B of user 903B or private email or text messages of other users. In such cases, the user may consent to having their emails scraped for event locations and dates, along with intended participants. This information may be stored in the event database 902, and may be drawn upon by the scheduling system 901 when identifying contextual details related to an event.

The scheduling system 901 may also have access to a variety of other information sources including weather services 908, travel or traffic services 909, and business services 910 or other third party services. Each of these services may provide different types of data which may be used by the scheduling system 901 when making decisions. The weather services 908 may include current weather forecasts, past weather forecasts, past weather conditions or current weather conditions, countrywide or local. The travel or traffic services 909 may include current and/or historical local vehicle traffic information, current and/or historical flight information for airplanes (e.g. from the Federal Aviation Administration (FAA)), public transportation information (e.g. buses, subways, streetcars, etc.) or other similar types of data.

The business services 910 may include data from business or government entities that monitor intersections, for example, or provide location data. Indeed, in some cases, the scheduling system 901 may have access to data or devices that indicate that certain users are located in a vehicle (from cell phone providers or GPS device location providers). The signaling system 121 in computer system 101, for example, may determine that a certain user is in a vehicle, may access that user's calendar information, and make determinations based on that data, in context with data from the other information sources shown in FIG. 9.

For example, the scheduling system 901 may determine that a group of users is going to the same event based on calendar information associated with the group of users. As shown in FIG. 9, the scheduling system 901 may have access to the private calendars 904A and 904B of users 903A and 903B, respectively. (Although two users are shown, it will be understood that substantially any number of users may be involved). The scheduling system 901 may determine that both users 903A and 903B are going to the same event according to their calendars and accepted or declined status. In such cases, the cue generator 109 of computer system 101 may generate cues for the each user that is going to the event. The cue 906A to user 903A may indicate that user 903B is planning to attend, and may suggest that they ride together, whereas the cue 906B to user 903B may indicate that user 903A is planning to attend and may provide a similar suggestion of riding together.

The scheduling system 901 may further be configured to access the public calendar 907 or other public or private events databases to identify future anticipated conditions related to a task (such as riding together to an event). The scheduling system 901 may identify scheduling conflicts, or may identify weather or traffic conditions that would affect the group carpool. As such, contextually relevant cues may be generated for the task based on calendar information from private individuals as well calendar information from public calendars. The contextually relevant cues for any given task may be based on any one or both of the identified future anticipated conditions, as well as any identified current conditions related to the task.

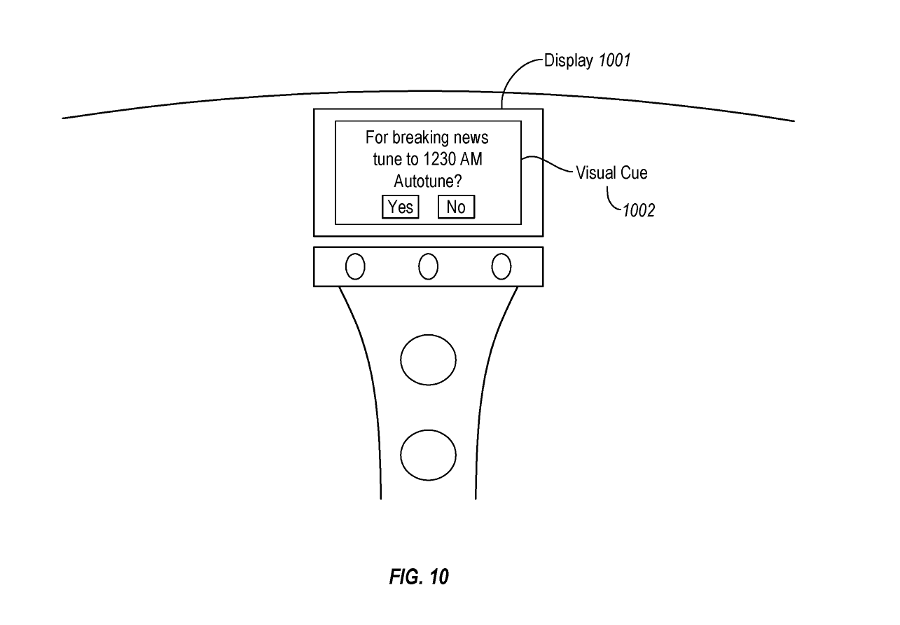

FIG. 10 illustrates an embodiment where a contextually relevant cue (e.g. 1002) may be generated and provided on a display 1001 based on information that is not necessarily related to a task, but is information in which the user is likely to be interested. For example, cloud systems or computer system 101 may be configured to monitor various data streams, including news streams, for information or events that are relevant to a user's task, or more generally, relevant or interesting to the user. The user may show interest in certain radio stations by setting them as presets, or may tune to a certain station whenever similar news events occur. Over time, the computer system 101 may learn the user's tendencies and preferences, and may anticipate interest on the user's behalf.

For instance, if a news event occurs, the computer system 101 may determine that the user will likely be interested in the news event, and may generate a cue that visually notifies the user of the event, or prompts the user to learn more about the event. One way of providing more information may be to determine which radio station is currently providing coverage of that story (or is at least likely to be providing coverage of that story), and may generate a cue prompting the user to tune to that radio station. Other forms of media may also be provided on the display 1001 including video data, web content, text messages (including short-form publicly broadcast messages) or other forms of media. In this manner, cues may be generated and provided to the user if the computer system 101 determines that the user would likely be interested in the information, even if that information is not directly related to a task.

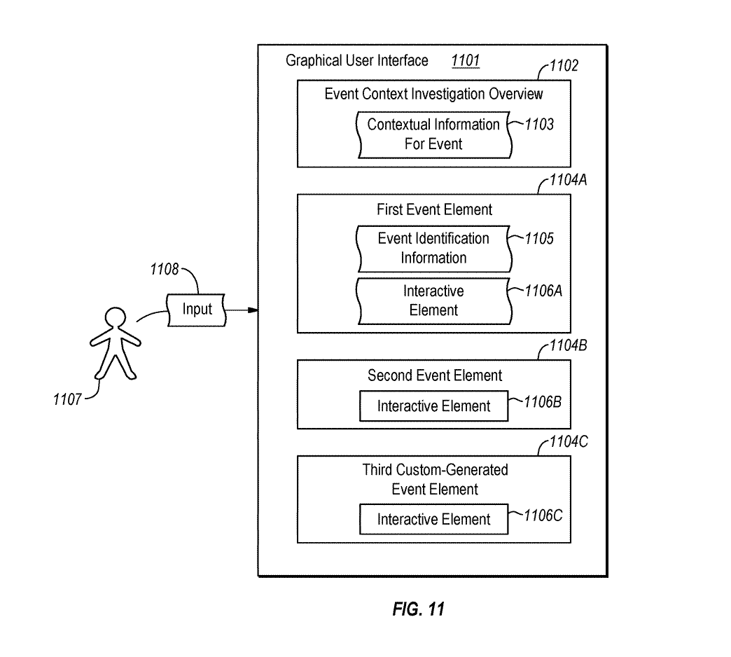

FIG. 11 illustrates an embodiment of a graphical user interface (GUI) in which event elements may be provided. These event elements allow a user to view and evaluate contextual information related to a task. In one embodiment, a computer program product may be provided, which includes one or more computer storage media having thereon computer-executable instructions which, when executed by one or more hardware processors of a computer system, cause the computer system to instantiate a GUI 1101 that includes multiple elements including an initial event context investigation overview screen 1102 that allows users to view and evaluate contextual information 1103 related to a task or event.

The overview screen 1102 may include a variety of event elements (1104A, 1104B, etc.) that include event or task identification information 1105. The event elements may also include interactive elements 1106A/1106B that allow users to drill down into contextual information related to the event or task. For example, in some cases, the event elements may be cue cards that have portions of information related to the event or task. Many different cue cards may be provided in the event overview 1102, although only three are shown in FIG. 11. The interactive elements included in the cue cards may be buttons, links, pictures, videos or any other item with which a user may interact. For instance, interactive element 1106A may be a button displayed on a touchscreen. The user 1107 may use touch inputs or other inputs 1108 to select the button, and drill down to uncover more detailed information associated with the event or task.

The interactive element 1106B of the second event element may, for example, be a picture or graphic that provides easily digestible information associated with the event or task. This picture or graphic may also be interacted with by the user 1107, and may lead the user to additional contextual information related to the event or task. The computer system that instantiates the GUI (e.g. computer system 101) may track inputs 1108 provided by the user 1107 to determine which cue cards are selected and which contextual information is determined to be relevant to the user. This allows future cue cards (e.g. 1104C) to be custom generated for the user based on the tracked inputs. The computer system 101 may learn which cue cards are most relevant to the user, and which interactive elements are most helpful to the user. Then, in the custom-generated event element 1104C, the most relevant or most useful interactive element 1106C may be used in the event element.

The computer system 101 may also apply a level of notification to the cue cards. The level of notification indicates that the notification is of high importance or relevance to the user, or is of low importance or relevance (or some grade in between). In such cases, the cue cards may only be displayed if the appropriate level of notification is met. The user 1107 may provide notification levels for various event elements based on their own interests, or the system may learn their preferences over time. The user 1107 may also provide input that configures visual or content portions of the visual elements.

The event elements may provide information regarding a wide variety of events or tasks including providing information on which route to take, when to drive based on weather- or event-related traffic patterns, reminders to perform tasks, helpful prompts on how to complete a task such as parking a vehicle in a parking lot, etc. The event elements may provide information about substantially any topic, and may take into consideration any of a number of current conditions or future anticipated conditions related to an event or task. The system may track user interactions with the system (including GUI 1101) to determine the user's preferences, and may adapt cue generation to suit the user.

Accordingly, methods, systems and computer program products are provided which provide contextually relevant cues to a user. Moreover, methods, systems and computer program products are provided which provide cues based on predicted conditions and/or based on current conditions. The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A method, implemented at a computer system that includes at least one hardware processor, for providing contextually relevant cues to a user, the method comprising:
identifying a task that is to be performed by the user;
accessing one or more data structures to identify one or more current conditions related to the identified task;
generating, based on the identified current conditions related to the task, one or more contextually relevant cues for the task, the contextually relevant cues providing suggestive information associated with the task;
providing the generated cue to the user.

2. The method of claim 1, further comprising providing one or more sub-tasks or suggestions associated with the generated cue that provide information indicating how the task is to be performed.

3. The method of claim 1, wherein the generated cue is provided to a driver of a vehicle, and wherein the cue is a brief, highly relevant verbal cue that tells the driver to perform a specific task prior to driving or while driving.

4. The method of claim 3, wherein the brief, highly relevant verbal cue is reproduced through a telematics device in the vehicle.

5. The method of claim 1, wherein the one or more identified current conditions include at least one publicly or privately scheduled event that is accessible through a public events database or a private events database.

6. The method of claim 5, further comprising looking at one or more calendar inputs from one or more users to determine current conditions based on events in the user's calendar.

7. The method of claim 5, further comprising accessing the public events database or the private events database to identify one or more future conditions related to the task, such that the contextually relevant cues for the task are based on both the identified current conditions and the identified future conditions.

8. The method of claim 1, wherein generating one or more contextually relevant cues for the task comprises determining how the contextually relevant cue can be generated concisely and still convey its intended meaning.

9. The method of claim 1, further comprising accessing the one or more current conditions to learn how the user behaves over time, such that the contextually relevant cues for the task are specific to the user.

10. The method of claim 9, wherein the contextually relevant cues are only generated and provided upon determining that the user has forgotten to perform the specified task.

11. The method of claim 1, wherein the contextually relevant cues are altered upon determining that at least one passenger is present with a driver in a vehicle.

12. One or more computer-readable media that store computer-executable instructions that, when executed, implement a method for providing cues based on predicted conditions, the method comprising:
identifying a user;
accessing one or more portions of historical data related to a task that is to be performed by the identified user;
identifying one or more anticipated conditions related to the task using the accessed historical information;
generating, based on the identified anticipated conditions, one or more contextually relevant cues related to the task that provide suggestive information associated with the task; and
providing the generated contextually relevant cues to the user.

13. The method of claim 12, wherein identifying one or more anticipated conditions related to the task using accessed historical information comprises accessing information related to one or more currently scheduled public or private events.

14. The method of claim 12, wherein cues are only generated and provided after determining that the contextually relevant cue is sufficiently pertinent to the user.

15. The method of claim 12, further comprising determining the current location of the user, and providing the generated cue to the user based on the user's current location.

16. The method of claim 12, further comprising:
determining that a group of users is going to the same event based on calendar information associated with the group of users; and
generating cues for the group of users indicating that they can ride together to the event.

17. A computer program product comprising one or more computer storage media having thereon computer-executable instructions that, when executed by one or more hardware processors of a computing system, cause the computing system to instantiate a graphical user interface (GUI) comprising the following:
an initial screen that allows users to view and evaluate contextual information related to a task;
a first cue card that has one or more portions of information related to the task; and
at least a second cue card that includes interactive elements that allow a user to drill down into contextual information displayed in the second cue card to find additional contextual information related to the task,
wherein the computer system tracks inputs provided by the user to determine which cue cards are selected and which contextual information is determined to be relevant to the user, allowing future cue cards to be custom generated for the user based on the tracked inputs.

18. The computer program product of claim 17, wherein the task comprises parking a vehicle in a parking lot, and wherein the first cue card includes information advising where to park within the parking lot.

19. The computer program product of claim 17, further comprising applying a level of notification to the first and second cue cards, such that the first and second cue cards are only displayed if the appropriate level of notification is met.

20. The computer program product of claim 17, wherein the additional contextual information related to the task is based on learned preferences identified from past user interactions with the GUI.
